(19) United States
(12) Patent Application Publication
(10) Pub. No.: US 2018/0031095 A1
(43) Pub. Date: Feb. 1, 2018

(54) DOUBLE CLUTCH TRANSMISSION AND METHOD FOR OPERATING A DOUBLE CLUTCH TRANSMISSION

(71) Applicant: ZF Friedrichshafen AG, Friedrichshafen (DE)

(72) Inventors: Stefan BLATTNER, Vogt (DE); Christian MITTELBERGER, Ravensburg (DE)

(21) Appl. No.: 15/549,887

(22) PCT Filed: Jan. 11, 2016
(86) PCT No.: PCT/EP2016/050336

§ 371 Date: Aug. 9, 2017

(30) Foreign Application Priority Data
Feb. 10, 2015 (DE) 10 2015 202 351.6

(51) Int. Cl. F16H 37/04; F16H 3/54; F16H 3/00; F16H 3/097; F16H 37/06

(52) U.S. Cl. CPC F16H 37/046; F16H 3/097; F16H 37/065; F16H 3/006; F16H 3/54; F16H 2200/006; F16H 2200/0091; F16H 2003/0933

(57) ABSTRACT

A dual clutch transmission for motor vehicles includes two sub-transmissions, each having an input shaft arranged on an input axis of the transmission. A drive output shaft on a drive output side of the transmission which is the drive output shaft of both sub-transmissions. At least two wheel planes and at least two shifting elements, and a countershaft arrangement with a countershaft axis that is parallel to the input axis. The countershaft arrangement includes two countershafts, the first one of which can be connected to transmission elements of all the wheel planes on the countershaft axis and the second countershaft is fixed to transmission elements of at least two wheel planes. Most of the shifting elements are double shifting elements and two of the shifting elements are arranged on the input axis and between the two wheel planes, whose transmission elements are connected fixed to the second countershaft.

This application is a National Stage completion of PCT/EP2016/050336 filed Jan. 11, 2016, which claims priority from German patent application serial no. 10 2015 202 351.6 filed Feb. 10, 2015.

### FIELD OF THE INVENTION

The invention concerns a dual clutch transmission for use in motor vehicles. The invention also concerns a method for operating a dual clutch transmission and a motor vehicle having a dual clutch transmission.

### BACKGROUND OF THE INVENTION

Transmissions for motor vehicles are designed, among others, as so-termed dual clutch transmissions in which, in each case, an input shaft is associated with a sub-transmission and in which the input shafts of the two sub-transmissions can be connected by a respectively associated powershift element with a drive input such as a combustion engine or an electric motor, the two powershift elements then being combined in the form of a dual clutch. The gears that can be produced by means of such a transmission are then divided in alternation between the two sub-transmissions, so that for example one sub-transmission produces the odd-numbered gears and the corresponding other sub-transmission produces the even-numbered gears. It is also known to produce the individual gear steps by means of one or more gearwheel stages or planes, each with a different gear ratio step. By virtue of corresponding shifting elements these can be connected into the force or torque flow between the drive input and the drive output, so that a corresponding desired transmission ratio is produced in each case between the drive input and the drive output.

Thanks to the alternate division of the gears between the two sub-transmissions it is possible, while driving in a gear associated with one of the sub-transmissions, already to preselect a subsequent gear in the respective other sub-transmission by appropriate actuation of the shifting devices, so that an ultimate shift to the subsequent gear is enabled by opening the powershift element of the one sub-transmission and, shortly after, closing the powershift element of the other sub-transmission. In this way the gears or gear steps of the transmission can be shifted under load, which improves both the ability of the motor vehicle to accelerate and the comfort of gearshift processes for the vehicle's driver, since the gearshift takes place essentially without traction force interruption.

Such dual clutch transmissions can also be made with an intermediate countershaft arrangement in addition to the drive input and the drive output, so that a more compact structure is produced in the axial direction.

From DE 10 2006 054 281 A1 a transmission for a motor vehicle in the form of a dual clutch transmission has become known. In this case the dual clutch transmission comprises two sub-transmissions, each with an input shaft. By connecting the input shafts by way of a respective powershift element, the two sub-transmissions can each be connected in alternation into a force or torque flow from a drive input to a drive output, wherein the input shaft of the first sub-transmission is in the form of a central transmission shaft and the input shaft of the second sub-transmission is in the form of a hollow transmission shaft. Furthermore an output shaft is provided which is designed as the drive output of both the sub-transmissions, so that rotational movement of the drive input can be transmitted to the drive output by way of a plurality of gear ratio steps in which the force and torque flow is led through a countershaft arrangement. During this at least two wheel planes are connected into the force and torque flow by actuating associated shifting elements, so that by a combination of the actuation of the shifting elements and the force and torque flow via corresponding wheel planes, several gear steps can be obtained. Likewise, a straight-through transmission of the rotational movement of the drive input to an output shaft of the drive output is possible by actuating appropriate shifting elements.

### SUMMARY OF THE INVENTION

A purpose of the present invention is therefore to make available a dual clutch transmission and a method for operating a dual clutch transmission, which provide as many gears as possible with as few wheel planes and as few shifting elements as possible. Also to provide good powershifting properties. Moreover, a purpose of the present invention is to provide a dual clutch transmission for a motor vehicle and a method for operating a dual clutch transmission, which can be produced and operated simply and inexpensively and at the same time enables reliable transmission of torques between the drive input and the drive output. A further purpose of the present invention is to indicate an alternative dual clutch transmission for a motor vehicle and an alternative method for operating a dual clutch transmission.

The present invention achieves these objectives with a dual clutch transmission for use in motor vehicles, which comprises two sub-transmissions each of which has an input shaft such that on an input side the two input shafts are arranged on an input shaft axis of the transmission, and on an output side of the transmission a drive output shaft which is the drive output shaft (AW) of both sub-transmissions, with at least two wheel planes and in particular seven wheel planes, and at least two shifting elements and in particular eight shifting elements and a countershaft arrangement with a countershaft axis, in particular one that is arranged parallel to the input shaft axis, the countershaft arrangement having at least two countershafts, a first countershaft being connected and/or connectable to transmission elements of all the wheel planes on the countershaft axis and a second countershaft being connected fixed to transmission elements of at least two wheel planes, wherein most of the shifting elements are in the form of double shifting elements and two shifting elements are arranged on the input shaft axis between the two wheel planes, whose transmission elements are connected fixed to the second countershaft.

The present invention also achieves the objectives with a method for operating a dual clutch transmission as described below with two clutches and eight shifting elements, in that
a first gear is obtained by closing the second clutch and also closing the first and eighth shifting elements, and in that
a second gear is obtained by closing the first clutch and also closing the eighth shifting element, and in that
a third gear is obtained by closing the second clutch and also closing the second and eighth shifting elements, and in that
a fourth gear is obtained by closing the first clutch and also closing the fourth shifting element, and in that
a fifth gear is obtained by closing the second clutch and also closing the first and seventh shifting elements, and in that
a sixth gear is obtained by closing the first clutch and also closing the fifth and seventh shifting elements, and in that
a seventh gear is obtained by closing the second clutch and also closing the second and seventh shifting elements,
   whereas in each case all the other clutches and shifting elements remain open.

The invention also achieves the objectives with a vehicle, in particular a passenger car or a truck, which has a dual clutch transmission as described.

One of the advantages achieved thereby is that in this way a large number of fully powershiftable gears can be made available as well as powershiftable gears by way of support gearshifts with the fewest possible shifting elements and wheel planes.

The term “wheel stage” or “wheel plane” in the description and particularly in the claims is preferably understood to mean essentially two transmission elements that co-operate to transmit torques from one transmission element to the other transmission element, such that preferably a stepped-down or stepped-up ratio is obtained in particular for transmission shafts that co-operate with the transmission elements.

The term “shifting element” in the description and particularly in the claims is preferably understood to mean a device which has at least an open and a closed condition, such that in the open condition the device does not transmit any torque and in the closed condition the device can transmit a torque between two devices that co-operate with the device or shifting element.

The term “shifting device” in the description and particularly in the claims is preferably understood to mean at least one shifting element and at least one shifting element actuating device for actuating the at least one shifting element.

The term “transmission element” in the description and particularly in the claims is preferably understood to mean a device by means of which force and/or torque can be transmitted. Here, transmission elements can preferably be in the form of wheels, preferably gearwheels and in particular spur gears, bevel gears, worm gears or the like.

The term “double shifting element” in the description and particularly in the claims is preferably understood to mean two shifting elements and two separate shifting element actuating devices, particularly in the form of sliding sleeves, which can be actuated in such manner that at least one of the two shifting elements is closed and at the same time the respective other shifting element is open.

By way of a drive input shaft, particularly preferably torque or rotational movement of a drive input, for example that of a combustion engine, can be introduced into the transmission. Preferably, between the drive input shaft and the drive output shaft there is a starting element, such as a hydrodynamic torque converter or a flow clutch.

In what follows, a shaft is understood to mean not exclusively a—for example—cylindrical machine element mounted to rotate for the transmission of torques, but rather, the term includes connecting elements in general that connect individual components or elements to one another, in particular connecting elements that connect a plurality of elements to one another in a rotationally fixed manner.

Two elements are in particular said to be connected to one another if between the elements there exists a fixed, in particular rotationally fixed connection. In particular, such connected elements rotate at the same rotational speed.

In what follows, two elements are said to be connectable if a detachable connection exists between the elements. In particular, such elements rotate at the same rotational speed when the connection is in place.

The various components and elements in the invention can be connected to one another via a shaft or a connecting element, but also directly, for example by means of a weld joint, a press fit or some other connection mode.

In the description and particularly in the claims, a clutch is understood to mean a shifting element which, depending on its actuation condition, allows a relative movement between two components or forms a connection for the transmission of torque. A relative movement, for example, is understood to mean rotation of two components such that the rotational speed of the first component and the rotational speed of the second component differ from one another. Moreover, one of the two components may be rotating whereas the other components is at rest or is rotating in the opposite direction.

In what follows, a non-actuated clutch is understood to be an open clutch. This means that relative movement is possible between the two components. When the clutch is actuated or closed, the two components correspondingly rotate at the same rotational speed in the same direction.

Basically, it is also possible to use shifting elements which are closed in their non-actuated condition but open in their actuated condition. Accordingly, the association between function and shift condition is to be understood as the converse of that described above. However, in the example embodiments described with reference to the figures, the arrangement originally intended is that in which a shifting element is closed when actuated and open when not actuated.

Thanks to the use of planetary gearsets, particularly compact transmissions can be produced, so that a large degree of freedom exists as regards the arrangement of the transmission in the vehicle.

A planetary gearset comprises a sun gear, a planetary carrier or web and a ring gear. Mounted to rotate on the planetary carrier or web are planetary gearwheels or planetaries, which mesh with the teeth of the sun gear and/or the teeth of the ring gear.

The elements of a planetary gearset are understood to be, in particular, the sun gear, the ring gear, the planetary carrier or web and the planetary gearwheels or planetaries of the planetary gearset.

Particularly preferably the shifting elements can be actuated selectively, i.e. individually and according to need, whereby different gears can be produced by virtue of different gear ratios between the drive input shaft and the drive output shaft.

The larger the number of gears, the finer can a gear gradation within a large overall transmission spread be made so that, for example, an internal combustion engine of a motor vehicle can be operated in an optimum rotational speed range and therefore as economically as possible. At the same time this contributes toward increasing the driving comfort, since the combustion engine can preferably be operated at a low rotational speed level. Thus, for example, noise emissions produced by operating the combustion engine are also reduced.

Particularly suitable for this are shifting elements that can be actuated as necessary, such as electromechanical shifting elements or electromagnetic shifting elements. Compared in particular with conventional, hydraulically actuated shifting elements, these are known for particularly low and efficient energy demand since they can be operated almost free from losses. Moreover, in an advantageous way there is no need to maintain permanently a control pressure for the actuation of the for example conventional hydraulic shifting elements or to act permanently upon the shifting element concerned with the necessary hydraulic pressure when in its shifted condition. Consequently, for example further components such as a hydraulic pump are not needed provided that these serve exclusively for the control and supply of the conventional hydraulically actuated shifting elements. If the supply of other components with lubricant does not take place by way of a separate lubricant pump but by means of the same hydraulic pump, then at least this can be made smaller. Furthermore, any leaks that may occur at oil transfer points of the hydraulic circuit, in particular from rotating components, are eliminated. Particularly preferably, this also contributes toward increasing the efficacy of the transmission in the form of higher efficiency.

When shifting elements that can be operated as necessary, of the type mentioned above, are used, it is especially advantageous for these to be easily accessible from outside. Among other things this has the advantage that it is easy to supply the shifting energy required by the shifting elements. Accordingly, it is particularly preferable to arrange the shifting elements so that they can be easily accessed from outside. In the context of shifting elements easily accessible from outside means that no further components are associated with intermediate housings of the transmission and the shifting element, or that the shifting elements are particularly preferably arranged on the drive input shaft or on the drive output shaft.

The term “connectability” in the description and particularly in the claims is preferably understood to mean that in the case of a different geometrical position the same connection or link between interfaces is ensured, without crossing of individual connecting elements or shafts.

The term “stationary gear ratio” is understood to mean that gear ratio which is produced by the transmission ratio between the sun gear and the ring gear of the planetary gearset concerned, when the planetary carrier or web is stationary.

Expediently, all the shifting elements are in the form of double shifting elements. In that way pairs of shifting elements can be actuated in common by one shifting element actuating device, which saves both space and costs.

Advantageously, in the transmission the shifting elements are distributed symmetrically in the axial direction and/or arranged in alternation on the input shaft axis and the countershaft axis. In this way the fitting space in the axial direction can be reduced, for example when they are arranged in alternation on the input and countershaft axes. Furthermore, by virtue of the reduced fitting space the flexibility of the transmission for use in a variety of vehicles is increased.

Expediently, a shifting element is arranged on the drive output side of that wheel plane of the two wheel planes which is positioned farthest on the drive output side, whose transmission elements are directly connected to the second countershaft. This can reduce the fitting space in the area of the two wheel planes, since the two shifting elements on the input shaft axis are arranged between the two wheel planes.

Advantageously, by means of the shifting element the two countershafts can be connected. In that way a connection for the transfer of force and torques can be produced in a simple manner by the shifting element of the two countershafts.

Expediently, one of the wheel planes is designed as a reversing gear stage in order to provide at least one reversing gear. Thereby, the rotational direction of the drive output shaft can be reversed relative to one of the input shafts. Thanks to the at least one reversing gear the flexibility in relation to the use of the transmission in a variety of vehicles is substantially increased.

Advantageously, the reversing gear is arranged in the drive output side half of the transmission, particularly—in the sequence of wheel planes from the drive input to the drive output side—in an odd-numbered wheel plane position. In this way the loading of the transmission in the drive input side half, i.e. the first half of the transmission between the drive input side and the drive output side can be reduced. If the reversing gear is arranged in an odd-numbered wheel plane position, this makes it simpler to obtain the reversing gear in the transmission at the same time as providing sufficient flexibility, so that even a plurality of reversing gear steps are made possible by connecting further wheel planes into the force and torque flow.

Expediently, the reversing gear stage is arranged as the last wheel plane in the sequence of wheel planes from the drive input side to the drive output side. One of the advantages achieved thereby is that the reversing gear stage is easy to maintain, since it is arranged directly on the drive output side.

Expediently, a single shifting element is arranged on each of the input shaft axis and the countershaft axis. In this way, for example, an odd number of shifting elements is enabled in the transmission with the greatest possible compactness of the other shifting elements in the form of respective double shifting elements. Likewise, by means of the single shifting elements so arranged respective appropriate shafts and/or wheel planes can be engaged in a flexible manner.

Advantageously, two single shifting elements are arranged on the input shaft axis or on the countershaft axis. This further increases the flexibility of the transmission, since single shifting elements can each be actuated separately in contrast to double shifting elements. If the two single shifting elements are arranged on the input shaft axis or the countershaft axis, the flexibility of the transmission in relation to obtaining gears and in relation to its use in a variety of vehicles is further increased.

Expediently, the two single shifting elements are arranged between the same wheel planes. This reduces the fitting space of the transmission in the axial direction.

Advantageously, the two shifting elements next and close to the drive output side and/or the drive input side are arranged on the input shaft axis or on the countershaft axis, in particular when they are in the form of double shifting elements. This allows the fitting space in the area of the drive input side and/or the drive output side, respective, to be adapted flexibly to external requirements. For example, if the two shifting elements next and close to the drive input side are arranged on the countershaft axis, the fitting space in the area of the clutches can be reduced considerably. For example, if the two shifting elements are arranged on the input shaft axis, the area of the countershaft arrangement close to the drive input side can be made compact.

Expediently, most of the shifting elements and in particular all except for one single shifting element are arranged on the input shaft axis. One advantage achieved thereby is that the fitting space of the countershaft arrangement is reduced considerably.

Advantageously, a range group and in particular a planetary range group is arranged on the drive output shaft, in particular wherein the drive output shaft now serves as the sun shaft of the planetary range group. A planetary range group has the advantage that it essentially doubles the number of gear steps that can be obtained with the transmission, and this still further improves the flexibility of the dual clutch transmission in relation to its use in a variety of vehicles.

Expediently two shifting elements are provided for actuating the range group, such that by means of one of the shifting elements a connection can be formed to a rotationally fixed housing and by means of the other shifting element two elements of the range group can be coupled. In this way the range group can be actuated simply. In this case the two shifting elements can be in the form of a double shifting element.

Advantageously, the shifting elements in the drive output half of the transmission are in the form of claw shifting elements and/or double claw shifting elements. This enables reliable actuation of the shifting elements, at the same time as low manufacturing costs for the shifting elements.

In a particularly advantageous design, two of the three shifting elements are in the form of claw shifting elements. In particular, these can be the shifting elements by way of which the reversing gear and gears 1 to 3 are obtained.

Expediently, one of the shifting elements is designed for the actuation of the reversing gear stage. This ensures a particularly simple and at the same time reliable actuation of the reversing gear stage.

Advantageously, seven wheel planes including one reversing gear stage and eight shifting elements are provided, and at least eight and in particular nine forward gears and/or at least three reversing gears can be obtained. An advantage is the great flexibility of the transmission, which makes it suitable for use in a variety of different motor vehicles. Moreover, thanks to the large number of forward gears a motor vehicle having this transmission can be operated better in the optimum range for the internal combustion engine, and this reduces fuel costs in particular.

Expediently, the forward gears and/or the reversing gears are sequentially fully powershiftable. This ensures good powershifting ability of the transmission.

Advantageously, one of the gears that can be obtained with the transmission is an overdrive gear and another is a direct gear. Overdrive gears are those with a gear ratio smaller than one and a direct gear is one with a gear ratio equal to one, i.e. no gear ratio. In this way, gear steps with gear ratios smaller or equal to one can be obtained in a simple manner.

Expediently, in the sequence of shifts from lower to higher gears the overdrive gear comes before the direct gear, so that for a gearshift from a lower gear to the higher overdrive gear the same clutch can be actuated. This further increases the flexibility with which gears can be obtained, since an alternating actuation of the two clutches when upshifting, i.e. when shifting from a lower gear to a directly adjacent higher gear, is no longer necessary.

Advantageously, a gearshift into the overdrive gear takes place via a support gearshift by way of the direct gear. This enables such a shift to be carried out as a powershift.

Expediently, the overdrive gear cannot be actuated. This gives fully powershiftable gears without a support gearshift with a correspondingly identical shifting matrix.

Expediently, in a method according to the invention an eighth gear is obtained by closing the first clutch and also closing the third shifting element, and a ninth gear by closing the second clutch and also closing the second, third and fifth shifting elements. In this way a 9-gear dual clutch transmission is made available in a simple manner.

Advantageously, in a method according to the invention an eighth gear is obtained by closing the second clutch and also closing the first, third and fifth shifting elements, and a ninth gear by closing the first clutch and also closing the third shifting element. This has the advantage that the dual clutch transmission can be made available with alternative eighth and ninth gears.

Expediently, the eighth gear is not used in the shifting sequence. This gives a direct gear gearset with eight powershiftable gears without support gearshifts.

Advantageously, a first reversing gear is obtained by closing the second clutch and also the first and sixth shifting elements, a second reversing gear by closing the first clutch and also the fifth and sixth shifting elements, and a third reversing gear by closing the second clutch and also the second and sixth shifting elements. In this way a plurality of reversing gears are provided by the dual clutch transmission.

Further important features and advantages of the invention emerge from the subordinate claims, from the drawings and from the associated figure descriptions referring to the drawings.

It is understood that the features mentioned above and those still to be explained can be used not only in the combination indicated in each case, but also in other combinations or as stand-alone features, without going beyond the scope of the present invention.

Preferred designs and embodiments of the present invention are illustrated in the drawings and will be explained in greater detail in the description given below, wherein the same indexes refer to the same, or similar, or functionally equivalent components or elements.

### BRIEF DESCRIPTION OF THE DRAWINGS

The figures show, in each case schematically:

FIG. 1: A transmission according to a first embodiment of the present invention;

FIG. 2: A shifting diagram for a transmission according to the first embodiment of the present invention;

FIG. 3: A shifting matrix for a transmission according to the first embodiment of the present invention;

FIG. 4: A transmission according to a second embodiment of the present invention;

FIG. 5: A shifting diagram for a transmission according to the second embodiment of the present invention;

FIG. 6: A shifting matrix for a transmission according to the second embodiment of the present invention;

FIG. 7: A transmission according to a third embodiment of the present invention;

FIG. 8: A shifting diagram for a transmission according to the third embodiment of the present invention;

FIG. 9: A shifting matrix for a transmission according to the third embodiment of the present invention;

FIGS. 10, 10A: A transmission and a shifting diagram according to a fourth embodiment of the present invention:

FIGS. 11. 11A: A transmission and a shifting diagram according to a fifth embodiment of the present invention;

FIGS. 12, 12A: A transmission and a shifting diagram according to a sixth embodiment of the present invention;

FIGS. 13, 13A: A transmission and a shifting diagram according to a seventh embodiment of the present invention;

FIGS. 14, 14A: A transmission and a shifting diagram according to an eighth embodiment of the present invention;

FIGS. 15, 15A: A transmission and a shifting diagram according to a ninth embodiment of the present invention;

FIGS. 16, 16A: A transmission and a shifting diagram according to a tenth embodiment of the present invention;

FIG. 17: A transmission and a shifting diagram according to an eleventh embodiment of the present invention;

FIG. 18: A shifting matrix for a transmission according to the eleventh embodiment of the present invention;

FIG. 19: A transmission according to a twelfth embodiment of the present invention; and

FIGS. 20, 20A: Shifting matrixes for a transmission according to the twelfth embodiment of the present invention.

### DETAILED DESCRIPTION OF THE PREFERRED EMBODIMENTS

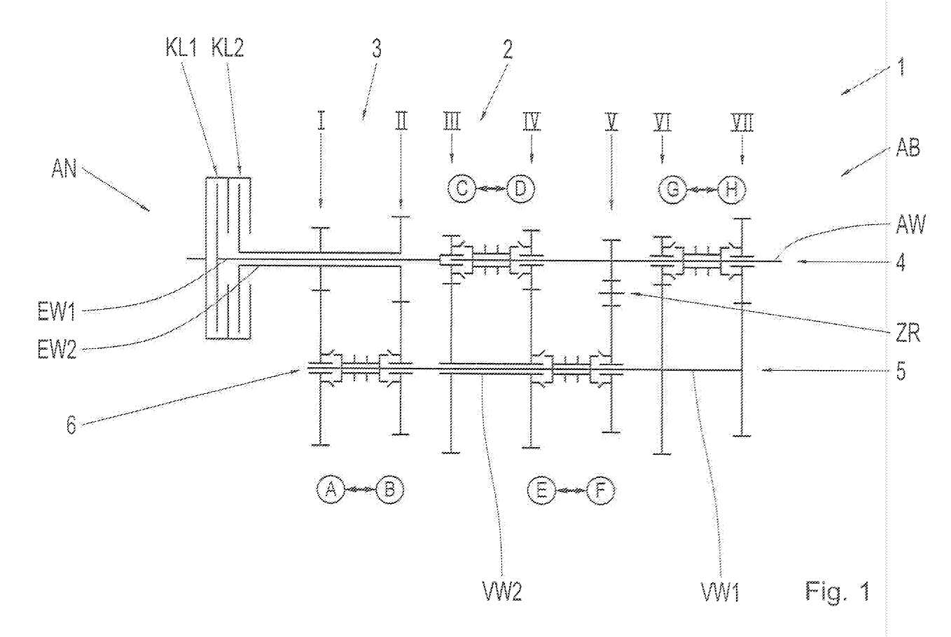

FIG. 1 shows a transmission according to a first embodiment of the present invention.

In FIG. 1 the index 1 denotes a dual clutch transmission. The dual clutch transmission 1 has two powershift elements in the form of clutches KL1, KL2. By means of the dual clutch transmission KL1, KL2 the drive input side AN can be coupled or connected to the drive output side AB of the transmission 1 for the transmission of force and torques. For this the first clutch KL1 is connected to a first input shaft EW1 and the second clutch KL2 is connected to a second input shaft EW2. In this case the second input shaft EW2 is in the form of a hollow shaft, whereas the first input shaft EW1 is a solid shaft. The two input shafts EW1, EW2 are arranged coaxially and parallel to one another.

A drive input shaft can connect the two clutches KL1, KL2, for example to a motor.

Furthermore, the transmission 1 comprises two sub-transmissions 2, 3. The first sub-transmission 2 is or can be coupled to the first input shaft 2 and the second sub-transmission 3 to the second input shaft EW2. With the first sub-transmission 2 is associated at least a third wheel plane III, whereas with the second sub-transmission 3 are associated at least a first and a second wheel plane I, II.

Moreover, the transmission 1 has an input shaft axis 4 on which the two input shafts EW1, EW2 are arranged. Downstream from the two input shafts EW1, EW2 there is also arranged a drive output shaft AW.

Downstream from the drive input side AN of the transmission 1 in relation to the torque and force flow, and starting from the two clutches KL1, KL2, the transmission 1 has on the input shaft axis 4 first the first wheel plane I, the second wheel plane II, the third wheel plane III, a third shifting element C, a fourth shifting element D, a fourth wheel plane IV, a fifth wheel plane V, a sixth wheel plane VI, a seventh shifting element G, an eighth shifting element H, and a seventh wheel lane VII.

Each of the wheel planes I, II, III, IV, V, VI and VII comprises transmission elements, in particular in the form of gearwheels, which in this case are each connected to a shaft of the transmission 1 or can be connected thereto by means of a shifting element.

Parallel to the input shaft axis 4 is arranged a countershaft axis 5 for a countershaft arrangement 6. The countershaft arrangement 6 comprises on the countershaft axis 5 a countershaft VW1 in the form of a solid shaft, with a countershaft VW2 parallel to it and in the form of a hollow shaft. Between the input shaft axis 4 and the countershaft axis 5 the fifth wheel plane V has an intermediate gearwheel ZR for reversing the rotation direction, so that by means of the drive output shaft AW, with the same rotation direction of one of the input shafts EW1, EW2 a reversed rotation direction for the provision of at least one reversing gear is made possible. Thus, the fifth wheel plane V is designed as a reversing gear stage.

Starting from the drive input side AN, the countershaft axis 5 has the first wheel plane I, a first shifting element A, a second shifting element B, the second wheel plane II, the third wheel plane III, the fourth wheel plane IV, a fifth shifting element E, a sixth shifting element F, the fifth wheel plane V, the sixth wheel plane VI and the seventh wheel plane VII.

Below, the eight shifting elements A, B, C, D, E, F, G and H will now be described.

The first shifting element A is arranged on the countershaft axis 5 and is connected on one side to the first countershaft VW1 and on the other side to a transmission element of the first wheel plane I. When actuated, the first shifting element A forms a connection for the transmission of force and torques between the first wheel plane I and the first countershaft VW1.

The second shifting element B is arranged on the countershaft axis 5 and is connected on one side to the first countershaft VW1 and on the other side to a transmission element of the second wheel plane II. When actuated, the second shifting element B forms a connection for the transmission of force and torques between the first countershaft VW1 and the second wheel plane II.

The third shifting element C is arranged on the input shaft axis 4 and is connected on one side to the first input shaft EW1 and to a transmission element of the third wheel plane III and on the other side to the drive output shaft AW. When actuated, the third shifting element C forms a connection for the transmission of force and torques between the first input shaft EW1, the third wheel plane III and the drive output shaft AW.

The fourth shifting element D is arranged on the input shaft axis 4 and is connected on one side to the drive output shaft AW and on the other side to a transmission element of the fourth wheel plane IV. When actuated, the fourth shifting element D forms a connection for the transmission of force and torques between the fourth wheel plane IV and the drive output shaft AW.

The fifth shifting element E is arranged on the countershaft axis 5 and is connected on one side to the first countershaft VW1 and on the other side to the second countershaft VW2. On the second countershaft VW2 are arranged transmission elements of the third wheel plane III and the fourth wheel plane IV in the form of fixed wheels. When actuated, the fifth shifting element E forms a connection for the transmission of force and torques between the first countershaft VW1 and th3e second countershaft VW2.

The sixth shifting element F is arranged on the countershaft axis 5 and is connected on one side to the first countershaft VW1 and on the other side to a transmission element of the fifth wheel plane V. When actuated the sixth shifting element F forms a connection for the transmission of force and torques between the first countershaft VW1 and the fifth wheel plane V.

The seventh shifting element G is arranged on the input shaft axis 4 and is connected on one side to the drive output shaft AW and on the other side to a transmission element of the sixth wheel plane VI. When actuated, the seventh shifting element G forms a connection for the transmission of force and torques between the sixth wheel plane VI and the drive output shaft AW.

The eighth shifting element H is arranged on the input shaft axis 4 and is connected on one side to a transmission element of the seventh wheel plane VII and on the other side to the drive output shaft AW. When actuated, the eighth shifting element H forms a connection for the transmission of force and torques between the seventh wheel plane VII and the drive output shaft AW.

The first and second shifting elements A, B, the third and fourth shifting elements C, D, the fifth and sixth shifting elements E, F and the seventh and eighth shifting elements G, H are in each case combined in respective shifting devices as double shifting elements, and can in each case be actuated by a shared shifting element actuating device.

Onto the first input shaft EW1 is fixed the transmission element of the third wheel plane III, i.e. it is arranged thereon as a fixed wheel. On the second input shaft EW2 are arranged fixed the transmission elements of the first wheel plane I and of the second wheel plane II. On the first countershaft VW1 are arranged fixed the transmission elements of the sixth wheel plane VI and of the seventh wheel plane VII, whereas on the second countershaft VW2 are arranged the transmission elements of the third wheel plane III and of the fourth wheel plane IV in the form of fixed wheels. The transmission element of the fifth wheel plane V on the input shaft axis 4 is in the form of a fixed wheel for the drive output shaft AW.

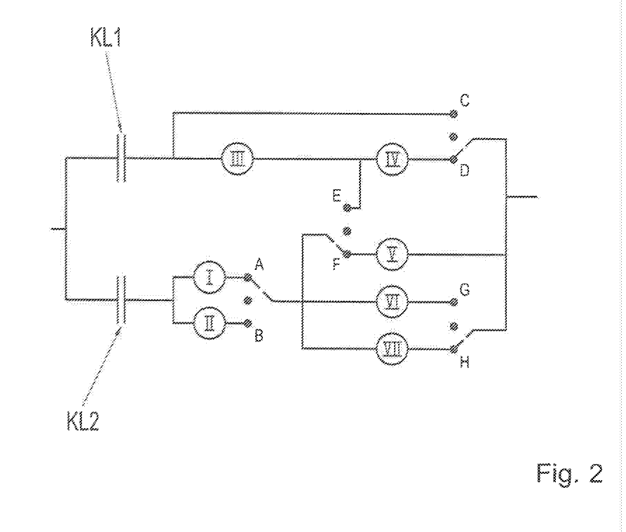

FIG. 2 shows a shifting diagram for a transmission according to the first embodiment of the present invention.

FIG. 2 shows the respective possible actuations of the shifting elements A to H together with the respective associated wheel planes I to VI for the production of gears. For example, if the second clutch KL2 is actuated, then by means of the shifting elements A or B the first or respectively the second wheel plane I, II can be connected into the torque flow. In FIG. 2 the shifting element A is actuated in this case. Furthermore, in FIG. 2 the shifting element H is actuated, so that the seventh wheel plane VII is connected into the force and torque flow from the drive input side AN to the drive output side AB. Overall, FIG. 2 thereby shows the first forward gear V1. For example, if the first clutch KL1 and the third shifting element C are actuated, no wheel plane is connected into the force and torque flow; consequently, the direct gear is obtained.

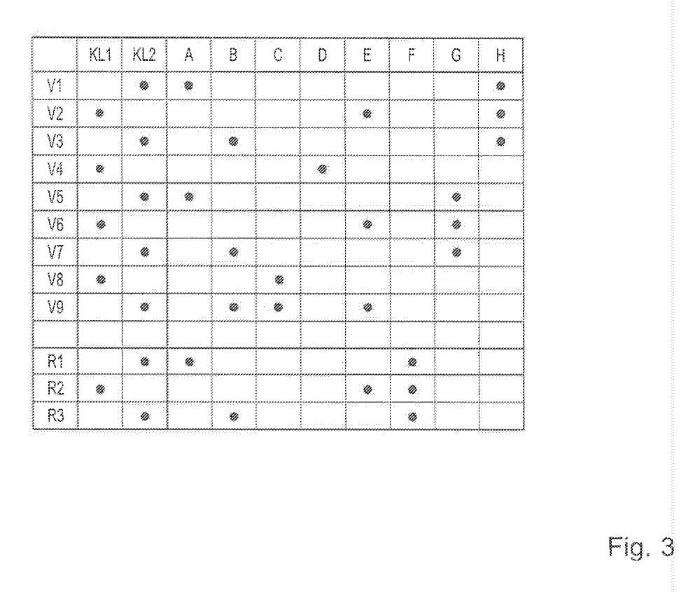

FIG. 3 shows a shifting matrix for a transmission according to the first embodiment of the present invention.

In FIG. 3 a shifting matrix for a transmission 1 according to FIGS. 1 and 2 is shown. Horizontally in the figure are shown columns A to H for the respective shifting elements and for the two clutches KL1 and KL2. Vertically downward are first the nine forward gears indexed V1 to V9 and then the three reversing gears indexed R1, R2 and R3. Cells left empty in the shifting matrix, for example for the forward gear V1 the cells for shifting elements B, C, D, E, F, G and the clutch KL1, indicate that the corresponding shifting elements and the corresponding clutch are open, i.e. that the shifting element or clutch in this case does not transmit any force or torque between the respective shafts fixed or connected to the shifting element or clutch. A cell containing a dot in the shifting matrix indicated a correspondingly actuated or closed shifting element or clutch, such as in the shifting matrix and for the forward gear V1 the clutch KL2 and the shifting elements A and H.

Overall, the transmission 1 according to FIGS. 1 to 3 has the following characteristics: Nine forward gears V1 to V9 are sequentially fully powershiftable. In all there are seven wheel planes I to VII including s reversing gear stage, as well as four double shifting elements A, B; C, D; E, F; G, H. In particular the shifting element F on the drive output side and the shifting element H on the drive output side for the first to third forward gears V1, V2 and V3 can be in the form of claw shifting elements. The reversing gear is obtained by way of the fifth wheel plane V. The sequence of Wheel planes VI and VII can also be exchanged. The same also applies to the wheel planes I and II, which can be exchanged. Moreover, the three reversing gears R1 to R3 are fully powershiftable.

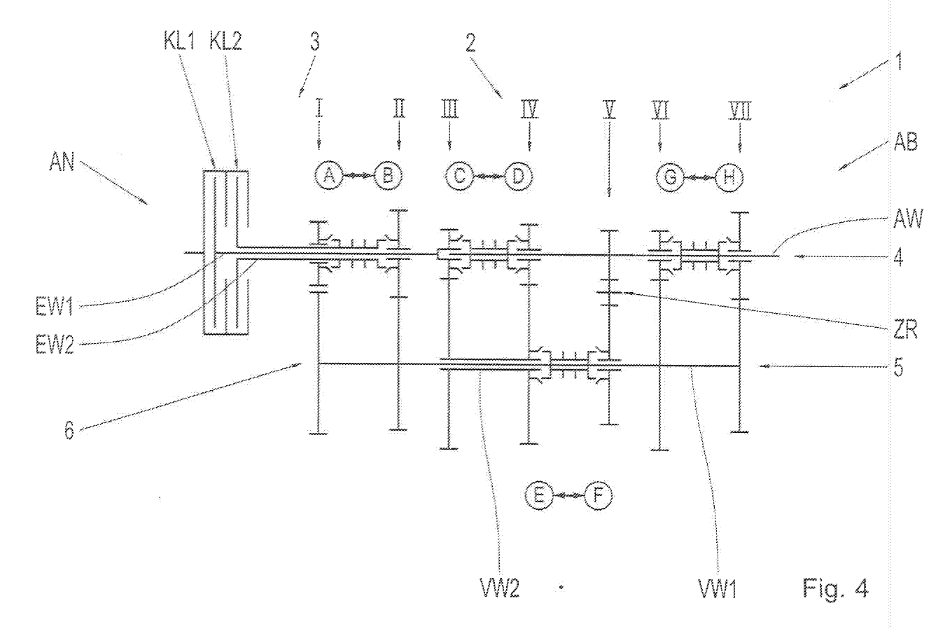

FIG. 4 shows a transmission according to a second embodiment of the present invention.

FIG. 4 shows a transmission 1 essentially like that of FIG. 1. The difference between the transmission 1 according to FIG. 1 and the transmission 1 according to FIG. 4 is the double shifting element comprising shifting elements A and B is now arranged on the input shaft axis 4 instead of on the countershaft axis 5.

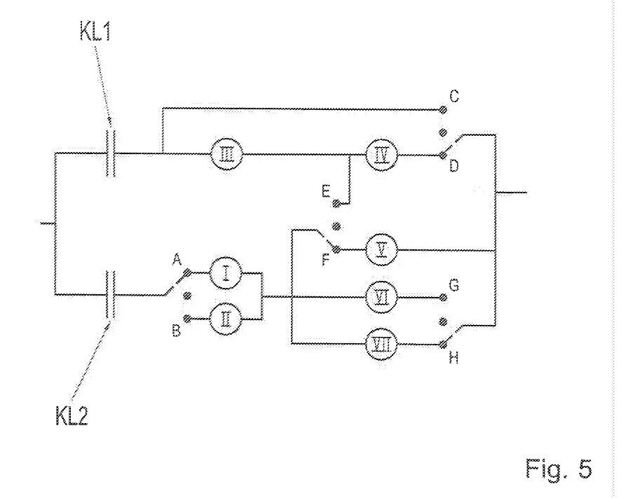

FIG. 5 shows a shifting diagram for a transmission according to the second embodiment of the present invention.

FIG. 5 shows the respective possible actuations of the shifting elements A to H together with the respective associated wheel planes I to VI for the production of gears. For example, if the second clutch KL2 is actuated, then by means of the shifting element A or B the first or second wheel plane I or II, respectively, can be connected into the torque flow. In FIG. 5 the shifting element A is actuated. In addition the shifting element H is actuated, so that the seventh wheel plane VII is connected into the force and torque flow from the drive input side AN to the drive output side AB. Overall, the first forward gear V1 is engaged in this way.

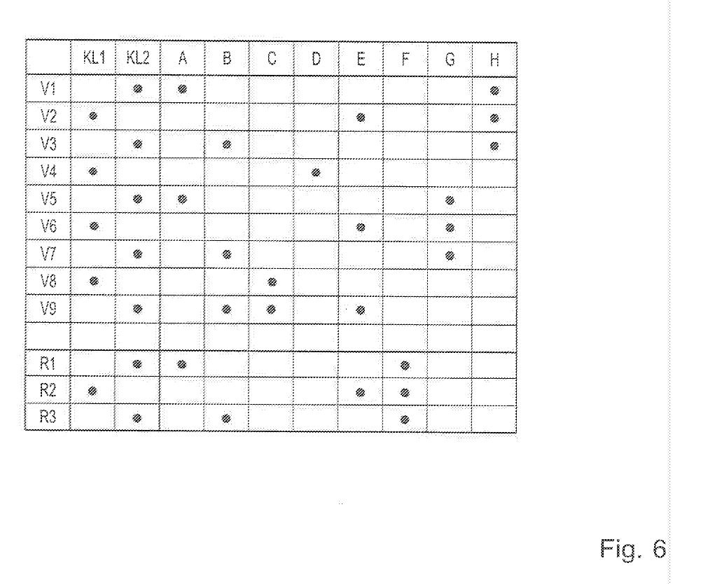

FIG. 6 shows a shifting matrix for a transmission according to the second embodiment of the present invention.

All told, the transmission 1 according to FIGS. 4 to 6 has the following characteristics: Nine forward gears V1 to V9, which are sequentially fully powershiftable. A total of seven wheel planes I to VII are provided, including a reversing gear stage, and four double shifting elements A, B; C, D; E, F; G, H. In particular the shifting element F on the drive output side and the shifting element H on the drive output side for the first to third forward gears V1 to V3 can each be in the form of claw shifting elements. The reversing gear is obtained by way of the fifth wheel plane V. The sequence of the wheel planes VI and VII can be exchanged. The same applies to the wheel planes I and II, which can be exchanged. In addition, the three reversing gears R1 to R3 are fully powershiftable.

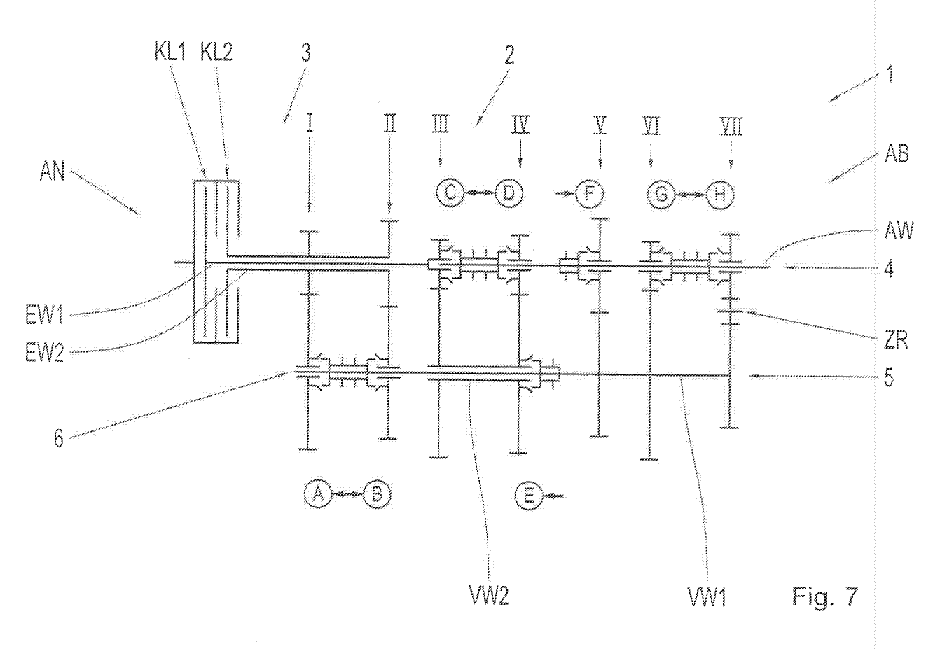

FIG. 7 shows a transmission according to a third embodiment of the present invention.

FIG. 7 shows a transmission 1 essentially like that of FIG. 1. The difference between the transmissions 1 in FIGS. 1 and 7 is that in FIG. 7 the sixth shifting element F is now arranged on the input shaft axis 4 instead of on the countershaft axis 5. In addition, the reversing gear stage is not the fifth wheel plane V but the seventh wheel plane VII. Furthermore, the fifth shifting element E and the sixth shifting element F are each in the form of single shifting elements.

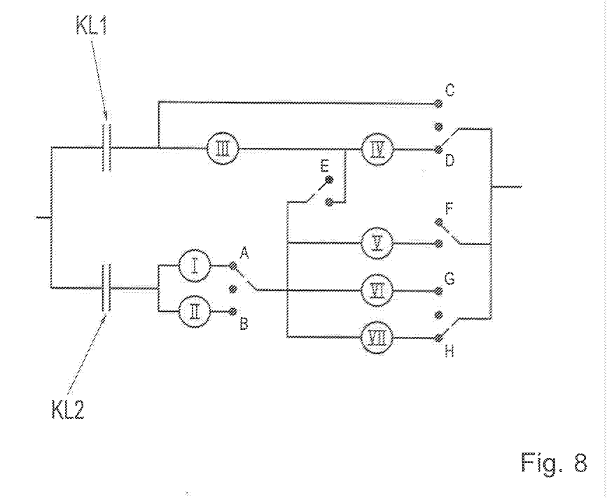

FIG. 8 shows a shifting diagram for a transmission according to the third embodiment of the present invention.

FIG. 8 shows the respective possible actuations of the shifting elements A to H together with the respective associated wheel planes I to VI for the production of gears. For example, if the second clutch KL2 is actuated, then by means of shifting element A or shifting element B respectively the first or second wheel plane I or II can be connected into the torque flow. Furthermore, in FIG. 8 the shifting element H is actuated so that the seventh wheel plane VII is connected into the torque flow from the drive input side AN to the drive output side AB. Overall, in this way the first forward gear V1 is obtained in FIG. 8. For example, if the first clutch KL1 and the third shifting element C are actuated, then no wheel plane is connected into the torque flow and the direct gear is therefore obtained.

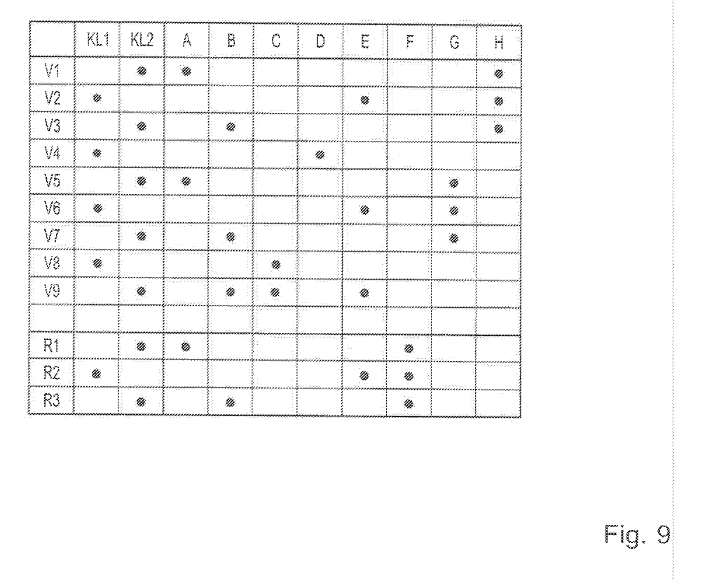

FIG. 9 shows a shifting matrix for a transmission according to the third embodiment of the present invention.

FIG. 9 shows essentially a shifting matrix for a transmission 1 according to FIG. 7. To explain the drawing, reference is also made to the description relating to FIG. 3.

All told, the transmission 1 according to FIGS. 7 to 9 has the following features: Nine forward gears V1 to V9 are sequentially fully powershiftable. There are provided a total of seven wheel planes I to VII, including a reversing gear stage, and three double shifting elements A, B; C, D; G, H and two single shifting elements E, F. In particular, the shifting element F on the drive output side for the reversing gear stage and the shifting element H on the drive output side for the first to third forward gears V1, V2 and V3 can each be made as a claw shifting element. The reversing gear is obtained by way of the seventh wheel plane VII. In this case the sequence of the wheel planes V, VI and VII and also the sequence of double shifting elements and the single shifting elements F, G H can also be reversed, and the same also applies to the wheel planes I and I, which can be exchanged. Moreover, the three reversing gears R1 to R3 are fully powershiftable. Preferably, the shifting element on the drive output side for the reversing gear stage and the shifting element on the drive output side for the first to third forward gears are combined in a double shifting element so that it can be made in the form of a double claw.

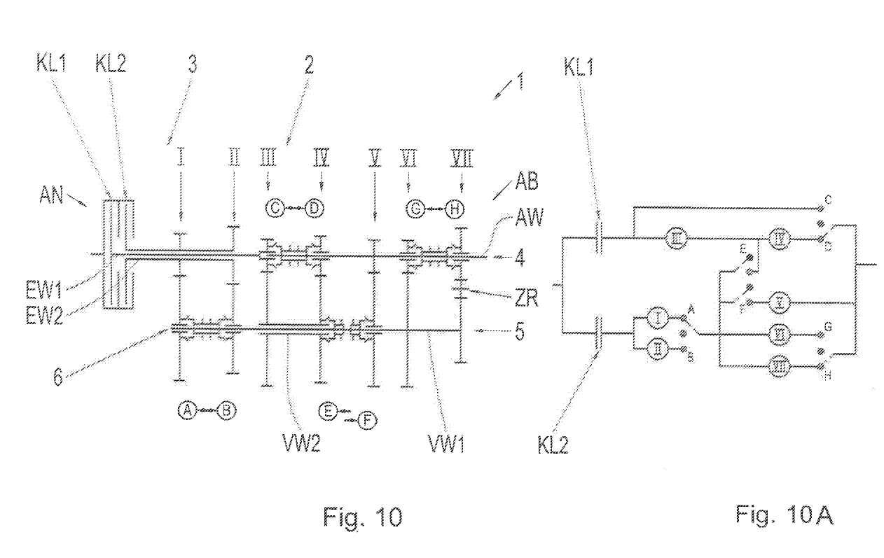

FIGS. 10 and 10A show a transmission and a shifting diagram according to a fourth embodiment of the present invention.

FIG. 10a shows a transmission 1 essentially like that of FIG. 1. The difference from the transmission 1 in FIG. 1 is that the fifth and sixth shifting elements E, F are this time not combined in a double shifting element but each is made as a single shifting element. Furthermore, the reversing gear stage R is in the form of the seventh wheel plane VII instead of the fifth wheel plane V.

FIG. 10A shows the respective possible actuations of the shifting elements A to H together with the associated wheel planes I to VI for the production of gears. For example, if the second clutch KL2 is actuated, then by means of the shifting elements A or B respectively, the first or second wheel plane I or II can be connected into the torque flow. In FIG. 10A the shifting element A is actuated in this case. Moreover, in FIG. 10A the shifting element H is actuated, so that the seventh wheel plane VII is connected into the torque flow from the drive input side AN to the drive output side AB. Thus, in FIG. 10A the first forward gear V1 is engaged in FIG. 10A. For example if the first clutch KL1 is actuated as well as the third shifting element C, then no wheel plane is connected into the force and torque flow; accordingly, the direct gear is obtained.

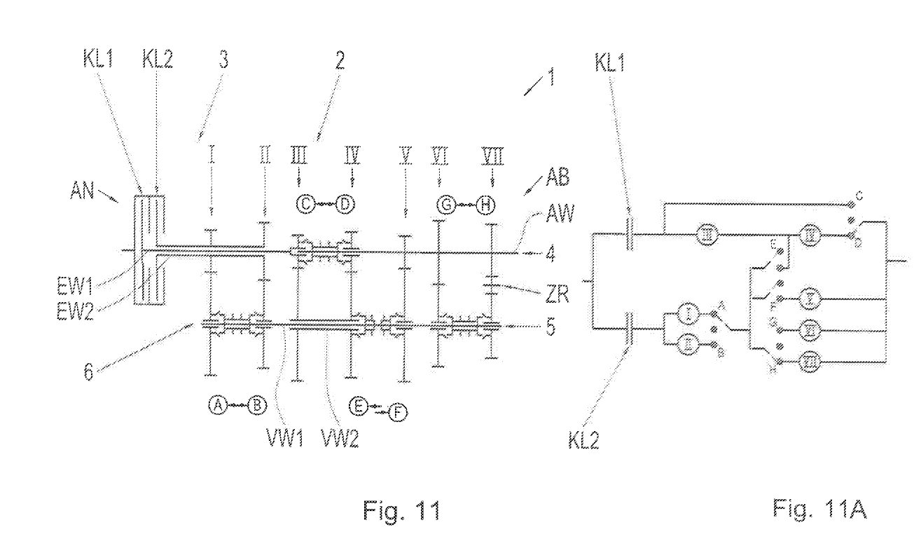

FIGS. 11 and 11A show a transmission and a shifting diagram according to a fifth embodiment of the present invention.

FIG. 11 shows a transmission 1 essentially like that of FIG. 1. The difference from the transmission shown in FIG. 1 is that in the transmission 1 according to FIG. 11 the seventh shifting element G and the eighth shifting element H are arranged on the countershaft axis 5 instead of on the input shaft axis 4. Furthermore, the reversing gear stage is now the seventh wheel plane VII instead of the fifth wheel plane V.

FIG. 11A shows the respective possible actuations of the shifting elements A to H together with the respectively associated wheel planes I to VI for the production of gears. For example, if the second clutch KL2 is actuated, then by means of the shifting elements A or B, respectively, the first or second wheel planes I or II can be connected into the torque flow. In FIG. 11A, in this case the shifting element A is actuated. In addition, in FIG. 11A the shifting element H is actuated so that the seventh wheel plane VII is connected into the force and torque flow from the drive input side AN to the drive output side AB. All told, this produces the first forward gear V1 in FIG. 11A. For example, if the first clutch KL1 and the third shifting element C are actuated, then no wheel plane is connected into the force and torque flow and accordingly the direct gear is obtained.

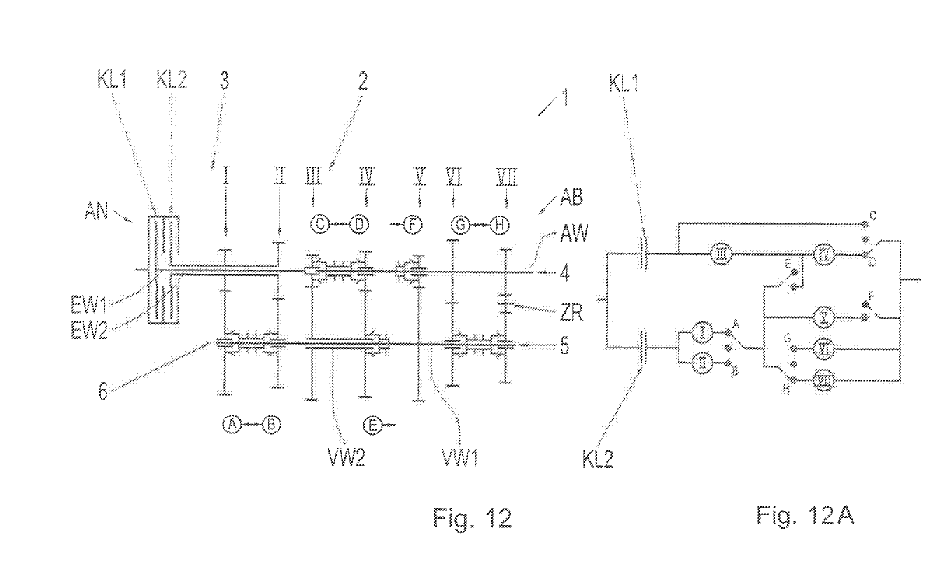

FIGS. 12 and 12A show a transmission and a shifting diagram according to a sixth embodiment of the present invention.

FIG. 12 shows a transmission 1 essentially like the transmission 1 shown in FIG. 1. The difference from the transmission 1 according to FIG. 1 is that in the transmission 1 of FIG. 12 the sixth shifting element F is arranged on the input shaft axis 4 instead of on the countershaft axis 5. Furthermore, the fifth shifting element E and the sixth shifting element F are now in the form of single shifting elements. Finally, the reversing gear stage R is the seventh wheel plane VII instead of the fifth wheel plane V.

FIG. 12A shows the respective possible actuations of the shifting elements A to H together with the wheel planes I to VI connected for the production of gears in each case. For example, if the second clutch KL2 is actuated, then by means of the shifting elements A or B, respectively, the first or second wheel planes I or II can be connected into the torque flow. In FIG. 12A the shifting element A is actuated in this case. In addition in FIG. 12A the shifting element H is actuated, so that the seventh wheel plane VII is connected into the force and torque flow from the drive input side AN to the drive output side AB. All told, the first forward gear V1 is engaged in FIG. 12A. For example if the first clutch KL1 and the third shifting element C are actuated, then no wheel plane is connected into the force and torque flow and the direct gear is therefore obtained.

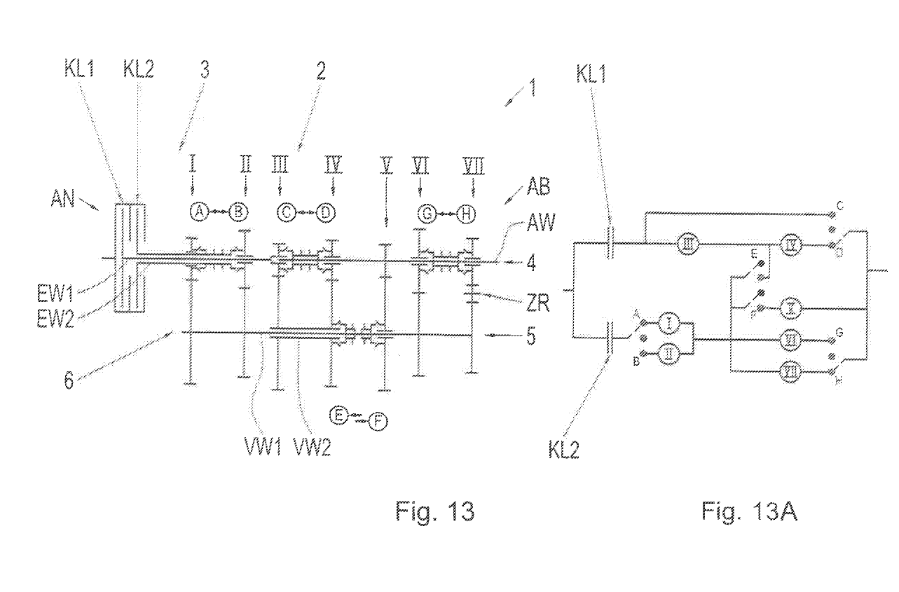

FIGS. 13 and 13A show a transmission and a shifting diagram according to a seventh embodiment of the present invention.

FIG. 13 shows a transmission 1 essentially like the transmission 1 in FIG. 1. The difference from the transmission 1 in FIG. 1 is that in the transmission 1 according to FIG. 13 the double shifting element comprising the shifting elements A and B is now arranged on the input shaft axis 4 instead of on the countershaft axis 5. Moreover, the two shifting elements E and F are not combined in a double shifting element, but each is made as a single shifting element. Finally, the reversing gear stage R is the seventh wheel plane VII instead of the fifth wheel plane V.

FIG. 13A shows the respective possible actuations of the shifting elements A to H together with the wheel planes I to VI connected for the production of gears in each case. For example, if the second clutch KL2 is actuated, then by means of the shifting elements A or B, respectively, the first or second wheel planes I or II can be connected into the torque flow. In FIG. 13A the shifting element A is actuated. Furthermore, in FIG. 13A the shifting element H is actuated so that the seventh wheel plane VII is connected into the force and torque flow from the drive input side AN to the drive output side AB. All told, the first forward gear V1 is thereby engaged in FIG. 13A. For example, if the first clutch KL1 and the third shifting element are actuated, then no wheel plane is connected into the force and torque flow so that the direct gear is obtained.

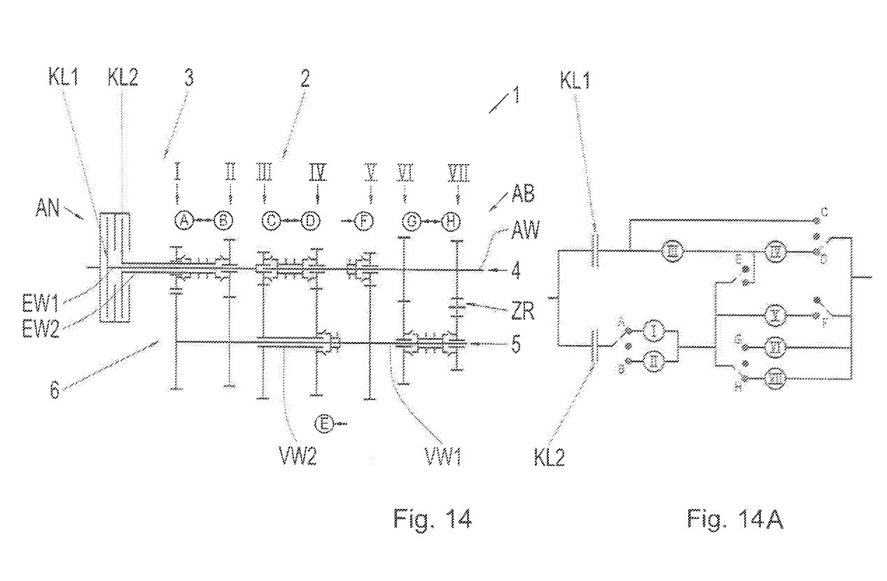

FIGS. 14 and 14A show a transmission and a shifting diagram according to an eighth embodiment of the present invention.

FIG. 14 shows a transmission essentially like the transmission 1 according to FIG. 1. The difference from the transmission 1 of FIG. 1 is that in the transmission 1 according to FIG. 14 the two shifting elements E and F are both made as single shifting elements, with the sixth shifting element F now arranged in the input shaft axis 4 instead of on the countershaft axis 5. Furthermore the double shifting element comprising the two shifting elements A and b is arranged on the input shaft axis 4 instead of on the countershaft axis 5, and the double shifting element comprising the two shifting elements G and H is now arranged on the countershaft axis 5 instead of on the input shaft axis 4.

FIG. 14A shows the respective possible actuations of the shifting elements A to H together with the wheel planes I to VI connected for the production of gears in each case are shown. For example, if the second clutch KL2 is actuated, then by means of the shifting elements A or B, respectively, the first or second wheel planes I or II can be connected into the torque flow. In FIG. 14A the shifting element A is actuated. Furthermore, in FIG. 14A the shifting element H is actuated so that the seventh wheel plane VII is connected into the force and torque flow from the drive input side AN to the drive output side AB. All told, the first forward gear V1 is thereby engaged in FIG. 14A. For example, if the first clutch KL1 and the third shifting element are actuated, then no wheel plane is connected into the force and torque flow so that the direct gear is obtained.

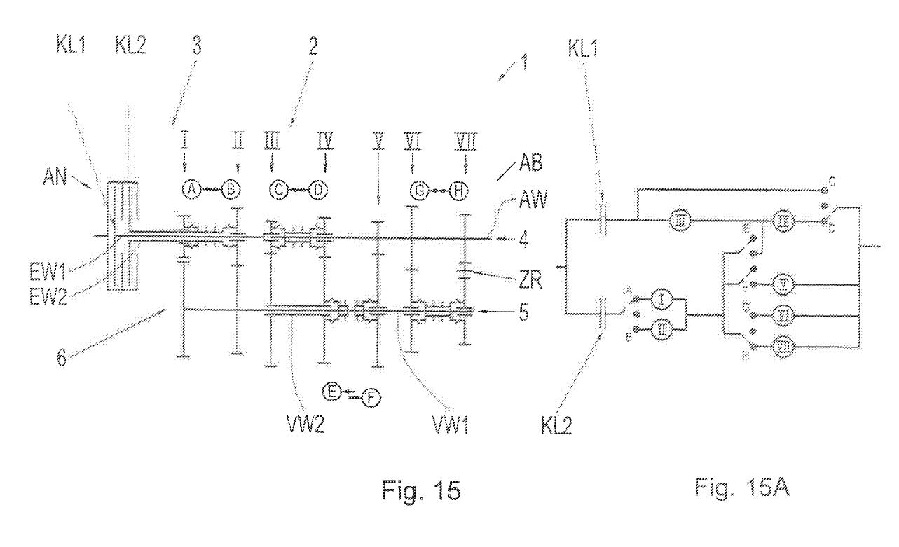

FIGS. 15 and 15A show a transmission and a shifting diagram according to a ninth embodiment of the present invention.

FIG. 15 shows a transmission essentially like the transmission 1 according to FIG. 1. The difference from the transmission 1 according to FIG. 1 is that the reversing gear stage R is now arranged or designed as the seventh wheel plane VII instead of the fifth wheel plane V. Furthermore, the double shifting element comprising the two shifting elements E and F is now split up and the two shifting elements E and F are now in the form of single shifting elements. In addition, the double shifting element comprising the two shifting elements G and H is now arranged on the countershaft axis 5 instead of on the input shaft axis 4. The double shifting element comprising the two shifting elements A and B, on the countershaft axis 5, is this time arranged on the input shaft axis 4.

FIG. 15A shows the respective possible actuations of the shifting elements A to H together with the wheel planes I to VI connected for the production of gears in each case. For example, if the second clutch KL2 is actuated, then by means of the shifting elements A or B, respectively, the first or second wheel planes I or II can be connected into the torque flow. In FIG. 15A the shifting element A is actuated. Furthermore, in FIG. 15A the shifting element H is actuated so that the seventh wheel plane VII is connected into the force and torque flow from the drive input side AN to the drive output side AB. All told, the first forward gear V1 is thereby engaged in FIG. 15A. For example, if the first clutch KL1 and the third shifting element are actuated, then no wheel plane is connected into the force and torque flow so that the direct gear is obtained.

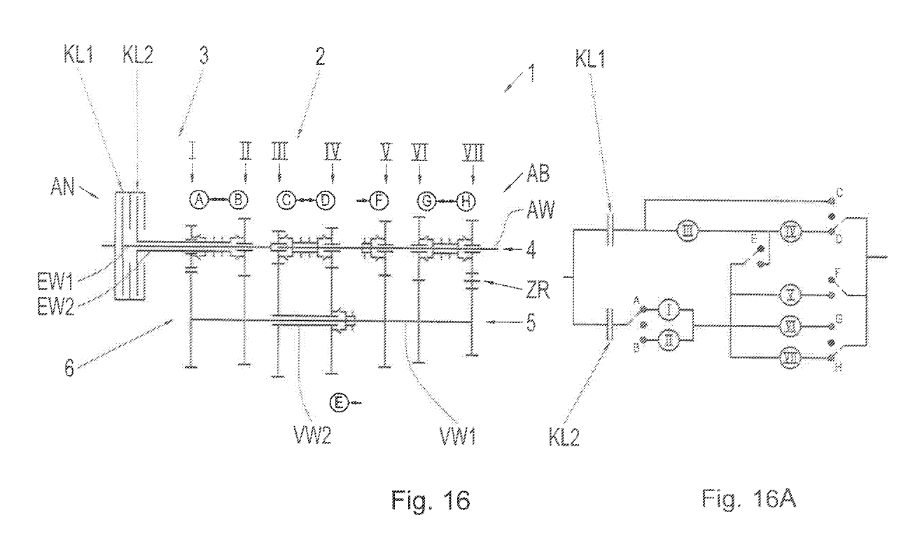

FIGS. 16 and 16A show a transmission and a shifting diagram according to a tenth embodiment of the present invention.

FIG. 16 shows a transmission essentially like the transmission 1 according to FIG. 1. The difference from the transmission 1 according to FIG. 1 is that in the transmission 1 according to FIG. 16 the double shifting element comprising the two shifting elements A and B are now arranged on the input shaft axis 4 instead of on the countershaft axis 5. Furthermore, the sixth shifting element F is now arranged on the input shaft axis 4 instead of on the countershaft axis 5. The two shifting elements E and F are again in the form of single shifting elements. Finally, the reversing gear stage R is now designed as the seventh wheel plane VII instead of the fifth wheel plane V.

Analogously to FIG. 15A, FIG. 16A shows the respective possible actuations of the shifting elements A to H together with the wheel planes I to VI connected for the production of gears in each case.

Overall, the transmissions according to FIGS. 10 to 16A have the following characteristics: Nine forward gears V1 to V9 are fully powershiftable. A total of seven wheel planes I to VII including a reversing gear stage are provided, as well as three double shifting elements A, B; C, D; G, H and two single shifting elements E, F. In particular, the drive output side shifting element F for the reversing gear stage and the drive output side shifting element H for the first to third forward gears V1, V2 and V3 can in each case be made as claw shifting elements. The reversing gear is obtained by way of the seventh wheel plane VII. In this connection the sequence of the wheel planes V, VI and VII can be changed as desired, as also can the sequence of double shifting elements or single shifting elements F, G, H. The same also applies to the sequence of wheel planes I and II, which can be exchanged. Moreover the three reversing gears R1 to R3 are fully powershiftable. Preferably, the drive output side shifting element for the reversing gear stage and the drive output side shifting element for the first to third forward gears are combined in a double shifting element so that this can be made as a double claw.

All in all, the transmissions according to FIGS. 1 to 16A have the following characteristics: The sequence of wheel planes V, VI and VII can also be changed as desired, as also can the connection of the wheel planes by means of the double shifting elements or the single shifting elements F, G, H. The same also applies to the sequence of the wheel planes I and II, which can be exchanged. Likewise, the transmission elements of the wheel planes I and II can also be connected to the countershaft in the form of fixed wheels and can be connected to the second input shaft EW2, which is a hollow shaft, by means of the shifting elements A, B on the input shaft axis 4. Each of the wheel planes V, VI and VII can also be connected fixed to the drive output shaft AW of the main transmission or the part of the transmission without the range group, and can be connected by means of the respective shifting element F, G or H to the countershaft VW1.

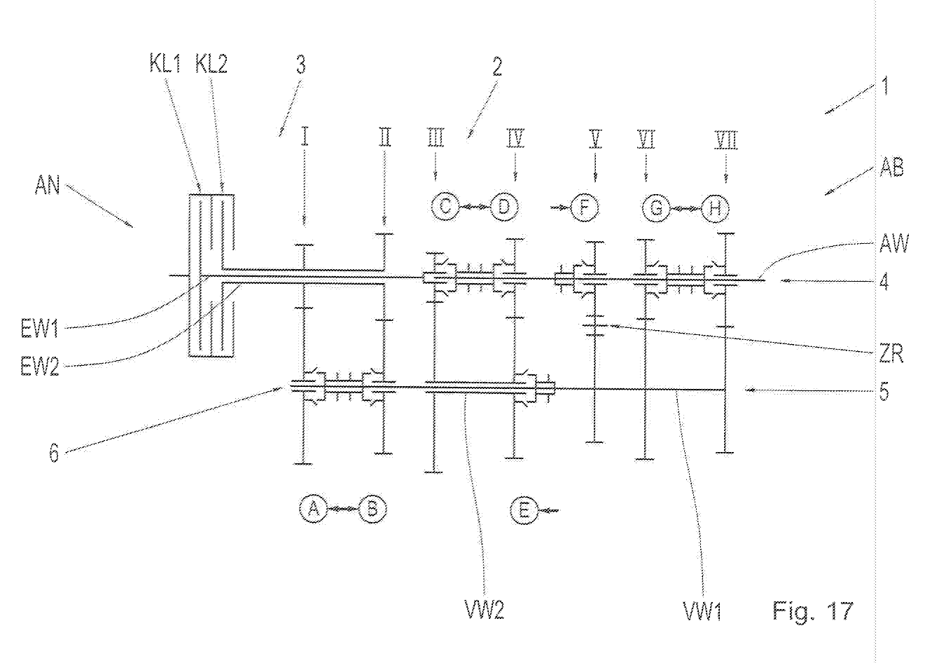

FIG. 17 shows a transmission and a shifting diagram for an eleventh embodiment of the present invention.

FIG. 17 shows a transmission 1 essentially like that of FIG. 1. The difference from the transmission 1 in FIG. 1 is that in the transmission 1 according to FIG. 17 the sixth shifting element F is now arranged on the input shaft axis 4 instead of on the countershaft axis 5. In addition, the two shifting elements E and F are no longer combined as a double shifting element, but they are each made as single a shifting element.

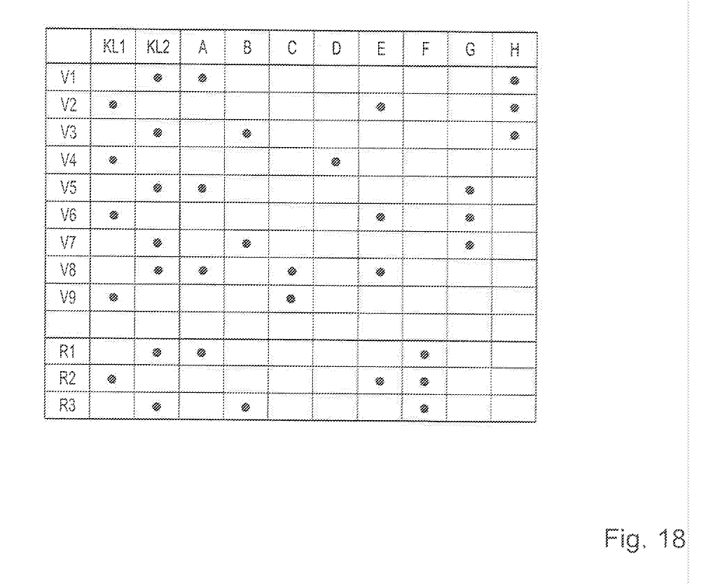

FIG. 18 shows a shifting matrix for a transmission according to the eleventh embodiment of the present invention.

FIG. 18 shows essentially a shifting matrix for a transmission 1 as in FIG. 17. To explain the drawing reference is made to the description relating to FIG. 3.

In contrast to the overdrive design of FIGS. 1 to 16, in the transmission 1 according to FIGS. 17 and 18 the seventh forward gear V7 and the eighth forward gear V8 are obtained by way of the same clutch KL2. A shift from the seventh forward gear V7 to the eighth forward gear V8 can therefore only take place as a support gearshift by way of the direct gear, i.e. forward gear V9. If with the transmission 1 according to FIGS. 17 and 18 the overdrive gear V8 is not used, then one has a fully powershiftable 8-gear direct gear gearset with gears V1 to V7, V9 without a support gear gearshift. Furthermore, there are three fully powershiftable reversing gears R1 to R3.

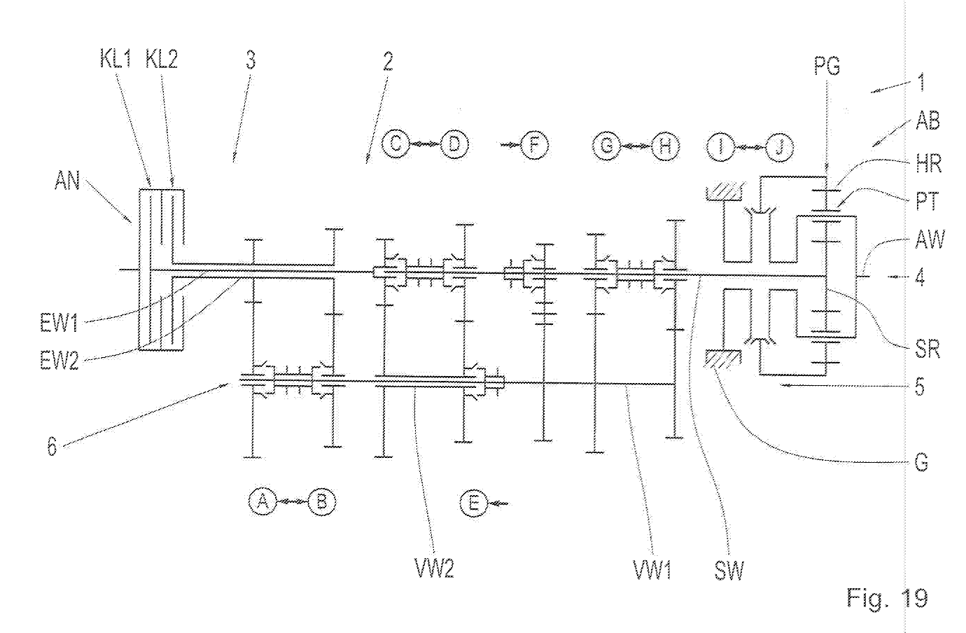

FIG. 19 shows a transmission according to a twelfth embodiment of the present invention.

FIG. 19 shows a transmission 1 essentially like that of FIG. 1. The difference from the transmission 1 of FIG. 1 is that in the transmission 1 of FIG. 19 the double shifting element E, F is now split and the two shifting elements E and F are each in the form of single shifting elements. Furthermore, the sixth shifting element F is now arranged on the input shaft axis 4 instead of on the countershaft axis 5. In addition a planetary range group PG is provided. The drive output shaft AW is now in the form of a sun shaft SW. In the usual manner the planetary gearset comprises a central sun gear SR, a planetary carrier PT and a ring gear HR. In addition a double shifting element I, J is provided. When the shifting element I is actuated a rotationally fixed connection is formed between the ring gear and a rotationally fixed housing G, whereas actuation of the shifting element J connects the planetary carrier PT to the ring gear and enables block rotation of the planetary gearset PG.

The drive output shaft AW is in this case connected to the web PT of the planetary gearset PG.

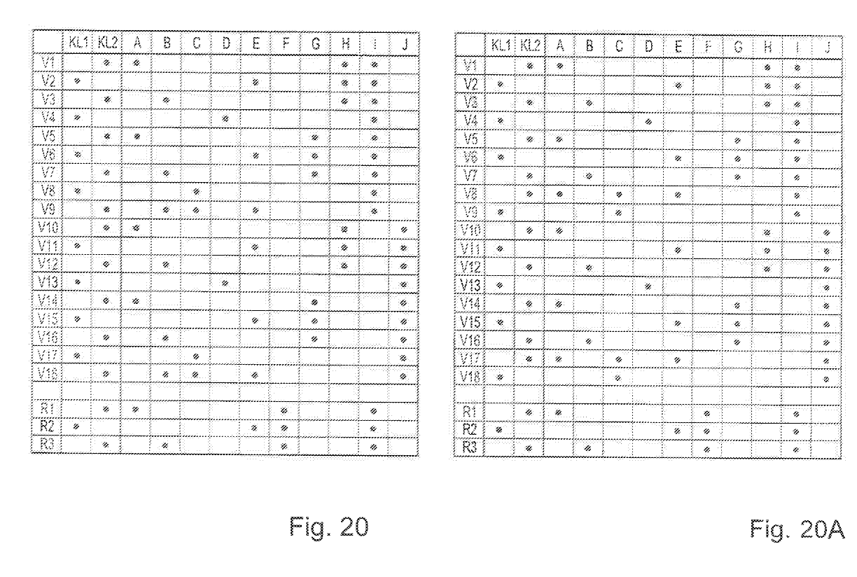

FIGS. 20 and 20A show shifting matrixes for a transmission according to th4e twelfth embodiment of the present invention.

In FIGS. 20 and 20a, respectively, example shifts for a transmission 1 according to FIG. 19 are shown. FIG. 20 shows an example of a shifting matrix for a 9-gear dual clutch transmission with an overdrive gear, whereas FIG. 20A shows shifting matrix for a 9×2 transmission with a direct gear DD. For the respective indexing reference can be made to the description relating to FIG. 3.

All the transmissions according to the above FIGS. 1 to 18 can be extended by a range group of planetary design PG. This enables an 18-gear gearset in which all the gearshifts without a shift in the range group are powershiftable. In the direct-gear variant according to FIGS. 17 and 18 the shift from the seventh forward gear V7 to the eighth forward gear V8 and from the sixteenth forward gear V16 to the seventeenth forward gear V17 are carried out as support gearshifts with the respective support gears V9 or V18. Likewise, there are three fully powershiftable reversing gears R1 to R3 for the slow as well as for the fast planetary gearset transmission ratio.

In summary, the present invention provides a sequentially fully powershiftable 9-gear dual clutch transmission with seven wheel planes and/or eight shifting elements. In particular, nine or eight fully powershiftable and gears that can be powershifted by way of support gearshifts, and in addition other, non-powershiftable gears can be obtained.

Although the present invention has been described above with reference to preferred example embodiments, it is not limited thereto but can be modified in many ways.

### INDEXES

1 Dual clutch transmission
2, 3 Sub-transmissions
4 Input shaft axis
5 Countershaft axis
6 Countershaft arrangement
AN drive input side
AB Drive output side
EW1, EW2 Input shafts
VW1, VW2 Countershafts
AW Drive output shaft
A, B, C, D, E, F, G, H Shifting element
I, II, III, IV, V, VI, VII Wheel p[lane
ZR Intermediate wheel
KL1, KL2 Clutch
V1, V2, V3, V4, V5, V6, V7 V8, V9, V10, V11, V12, V13 V14, V15, V16, V17, V18 Forward gear
R1, R2, R3 Reversing gear
G Housing
SR Sun gear
PT Planetary (gearwheel) carrier/Web
HR Ring gear
PG Planetary range group

1-31. (canceled)

32. A dual clutch transmission (1) for use in a motor vehicle, the dual clutch transmission comprising:
two sub-transmissions (2, 3), each of the sub-transmissions (2, 3) comprising at least one input shaft (EW1, EW2) such that the two input shafts (EW1, EW2) are arranged, on a drive input side of an input shaft axis (4) of the transmission (1),
a drive output shaft, on a drive output side (AB) of the transmission (1), being the drive output shaft (AW) of both sub-transmissions (2, 3),
at least two wheel planes (I, II, III, IV, V, VI, VII),
at least two shifting elements (A, B, C, D, E, F, G, H),
a countershaft arrangement (6) with a countershaft axis (5) being arranged parallel to the input shaft axis (4), and the countershaft arrangement comprises at least first and second countershafts (VW1, VW2), in which
the first countershaft (VW1) being connectable to transmission elements of all the wheel planes (I, II, III, IV, V, VI, VII) on the countershaft axis (5), and
the second countershaft (VW2) being connected fixed to transmission elements of at least two wheel planes (III, IV),
most of the shifting elements (A, B, C, D, E, F, G, H) are double shifting elements, and
two of the shifting elements (C, D) being arranged on the input shaft axis (4) and between the two wheel planes (III, IV) whose transmission elements are connected fixed to the second countershaft (VW2).

33. The dual clutch transmission according to claim 32, wherein all the shifting elements (A, B, C, D, E, F, G, H) are double shifting elements.

34. The dual clutch transmission according to claim 32, wherein the shifting elements (A, B, C, D, E, F, G, H), in the transmission (1), are at least one of:
distributed symmetrically in an axial direction, and
arranged in alternation on the input shaft axis (4) and the countershaft axis (5).

35. The dual clutch transmission according to claim 32, wherein one of the shifting elements (E) is arranged on the countershaft axis (5) on the drive output side of a wheel plane (IV) of the two wheel planes (III, IV) which is arranged farthest on the drive output side, the transmission elements of which are directly connected to the second countershaft (VW2).

36. The dual clutch transmission according to claim 35, wherein the two countershafts (VW1, VW2) are connectable by the one of the shifting elements (E).

37. The dual clutch transmission according to claim 32, wherein one of the wheel planes (V, VI, VII) is designed as a reversing gear stage to provide at least one reversing gear (R1, R2, R3).

38. The dual clutch transmission according to claim 37, wherein the reversing gear stage (V, VI, VII) is arranged in a half of the transmission (1) on the drive output side, in a sequence of wheel planes from the drive input side (AN) to the drive output side (AB) in an odd-numbered wheel plane position (V, VII).

39. The dual clutch transmission according to claim 37, wherein the reversing gear stage (V, VII) is arranged as a last wheel plane (VII) in a sequence of wheel planes from the drive input side (AN) to the drive output side (AB).

40. The dual clutch transmission according to claim 32, wherein a single respective shifting element (E, F) is arranged on the input shaft axis (4) and on the countershaft axis (5).

41. The dual clutch transmission according to claim 32, wherein two single shifting elements (E, F) are arranged on either the input shaft axis (4) or the countershaft axis (5).

42. The dual clutch transmission according to claim 40, wherein the two single shifting elements (E, F) are arranged between the same wheel planes (IV, V).

43. The dual clutch transmission according to claim 32, wherein the two shifting elements (A, B; G, H) next-closest to at least one of the drive output side (AB) and the drive input side (AN) are arranged either on the input shaft axis (4) or on the countershaft axis (5), and are each a double shifting element.

44. The dual clutch transmission according to claim 32, wherein most of the shifting elements (A, B, C, D, F, G, H) are arranged on the input shaft axis (4).

45. The dual clutch transmission according to claim 32, wherein a planetary range group (PG) is arranged on the drive output shaft (AW) and the drive output shaft (AW) is a sun shaft of the planetary range group (PG).

46. The dual clutch transmission according to claim 45, wherein two shifting elements (I, J) are provided for actuating the range group (PG) so that a connection is formed to a rotationally fixed housing (G) by a first of the two shifting elements (I) and two elements (PT, HR) of the planetary range group (PG) are couplable to one another by a second of the two shifting elements (J).

47. The dual clutch transmission according to claim 32, wherein the shifting elements (F, G, H) in a drive output side half of the transmission (1) are at least one of claw shifting elements and double claw shifting elements.

48. The dual clutch transmission according to claim 32, wherein two of three shifting elements (F, G, H) are claw shifting elements.

49. The dual clutch transmission according to claim 48, wherein one of the two shifting elements (F, H) is designed to actuate the reversing gear stage.

50. The dual clutch transmission according to claim 32, wherein the dual clutch transmission comprises seven wheel planes (I, II, III, IV, V, VI, VII), and one of the seven wheel planes is a reversing gear stage, eight shifting elements (A, B, C, D, E, F, G, H) are provided, and by the seven wheel planes and the eight shifting elements at least eight forward gears (V1, V2, V3, V4, V5, V6, V7, V8) and at least three reversing gears (R1, R2, R3) are obtainable.

51. The dual clutch transmission according to claim 50, wherein the at least eight forward gears (V1, V2, V3, V4, V5, V6, V7, V8) and the at least three reversing gears (R1, R2, R3) are sequentially powershiftable.

52. The dual clutch transmission according to claim 32, wherein a plurality of gears are obtainable by the transmission, and one of the gears that is obtainable by the transmission (1) is an overdrive gear (V9) and another one of the gears that is obtainable by the transmission is a direct gear (V8).

53. The dual clutch transmission according to claim 52, wherein the overdrive gear (V9) is obtained, in a sequential gearshift sequence from lower to higher gears, before the direct gear (V8), and for a gearshift from a lower gear (V7) to the higher overdrive gear (V8) the same clutch is actuated.

54. The dual clutch transmission according to claim 53, wherein a gearshift into the overdrive gear (V8) is obtained by a support gearshift via the direct gear (V9).

55. The dual clutch transmission according to claim 54, wherein the overdrive gear (V8) is unactuatable.

56. The dual clutch transmission according to claim 45, wherein all the gears that are obtainable (V1, V2, V3, V4, V5, V6, V7, V8, V9, R1, R2, R3) without a range group are powershiftable.

57. A method of operating a dual clutch transmission according to claim 32, with first and second clutches (KL1, KL2) and first, second, third, fourth, fifth sixth, seventh and eighth shifting elements (A, B, C, D, E, F, G, H), the method comprising:
obtaining a first gear (V1) by engaging the second clutch (KL2) and also engaging the first and the eighth shifting elements (A, H),
obtaining a second gear (V2) is obtained by engaging the first clutch (KL1) and also engaging the fifth and the eighth shifting element (H),
obtaining a third gear (V3) is obtained by engaging the second clutch (KL2) and also engaging the second and the eighth shifting elements (B, H),
obtaining a fourth gear (V4) is obtained by engaging the first clutch (KL1) and also engaging the fourth shifting element (D),
obtaining a fifth gear (V5) is obtained by engaging the second clutch (KL2) and also engaging the first and the seventh shifting elements (A, G),
obtaining a sixth gear (V6) is obtained by engaging the first clutch (KL1) and also engaging the fifth and the seventh shifting elements (E, G), and
obtaining a seventh gear is obtained by engaging the second clutch (KL2) and also engaging the second and the seventh shifting elements (B, G), and
in each case all of the other clutches and shifting elements remain disengaged.

58. The method according to claim 57, further comprising
obtaining an eighth gear (V8) by engaging the first clutch (KL1) and also engaging the third shifting element (C), and
obtaining a ninth gear (V9) by engaging the second clutch (KL2) and also engaging the second, the third and the fifth shifting elements (B, C, E).

59. The method according to claim 57, further comprising
obtaining an eighth gear (V8) by engaging the second clutch (KL2) and also engaging the first, the third and the fifth shifting elements (A, C, E), and
obtaining a ninth gear (V9) by engaging the first clutch (KL1) and also engaging the third shifting element (C).

60. The method according to claim 59, further comprising omitting use of the eighth gear (V8) in the gearshift sequence.

61. The method according to claim 59, further comprising
obtaining a first reversing gear (R1) by engaging the second clutch (KL2) and also engaging the first and the sixth shifting elements (A, F),
obtaining a second reversing gear (R2) by engaging the first clutch (KL1) and also engaging the fifth and the sixth shifting elements (E, F), and
obtaining a third reversing gear (R3) by engaging the second clutch (KL2) and also engaging the second and the sixth shifting elements (B, F).

62. A motor vehicle having a dual clutch transmission (1) comprising:
two sub-transmissions (2, 3), each of the two sub-transmissions (2, 3) comprising an input shaft (EW1, EW2) such that the two input shafts (EW1, EW2) are arranged, on a drive input side, on an input shaft axis (4) of the transmission (1),
a drive output shaft, on a drive output side (AB) of the transmission (1), as the drive output shaft (AW) of both of the two sub-transmissions (2, 3),
at least two wheel planes (I, II, III, IV, V, VI, VII),
at least two shifting elements (A, B, C, D, E, F, G, H),
a countershaft arrangement (6) with a countershaft axis (5) being arranged parallel to the input shaft axis (4), the countershaft arrangement comprising at least first and second countershafts (VW1, VW2), in which
the first countershaft (VW1) being connectable to transmission elements of all the wheel planes (I, II, III, IV, V, VI, VII) on the countershaft axis (5), and
the second countershaft (VW2) being fixedly connected to transmission elements of at least two of the at least two wheel planes (III, IV),
most of the at least two shifting elements (A, B, C, D, E, F, G, H) being double shifting elements, and
two of the at least two shifting elements (C, D) being arranged on the input shaft axis (4) and between the two of the at least two wheel planes (III, IV), whose transmission elements are connected fixed to the second countershaft (VW2).
